(19) United States
(12) Patent Application Publication
(10) Pub. No.: US 2007/0030878 A1
(43) Pub. Date: Feb. 8, 2007

(54) LASER ARRANGEMENT AND METHOD FOR THE GENERATION OF A MULTIMODE OPERATION WITH INTRACAVITY FREQUENCY DOUBLING

(75) Inventors: Guenter Hollemann, Jena (DE); Stefan Knoke, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Laser, Optik, Systeme GmbH

(21) Appl. No.: 11/419,021

(22) Filed: May 18, 2006

(30) Foreign Application Priority Data
May 27, 2005 (DE) 10 2005 025 128.5

(51) Int. Cl. H01S 3/10; H01S 3/07; H01S 3/08

(52) U.S. Cl. 372/67; 372/22; 372/98

(57) ABSTRACT

In a laser arrangement and a method for generating a multimode operation with intracavity frequency doubling, the object of the invention is to eliminate fluctuations in output caused by the nonlinear coupling between the longitudinal modes due to sum frequency generation in a simple laser construction which has increased thermal and mechanical stability. Two multimode spectral regions are situated in the edge areas of the spectral gain region of a disk-shaped gain medium within which longitudinal modes have no gain advantage among one another for spatial hole burning, and in which oscillation of one of the two multimode spectral regions is prohibited.

### CROSS-REFERENCE TO RELATED APPLICATION

This application claims priority of German Application No. 10 2005 025 128.5, filed May 27, 2005, the complete disclosure of which is hereby incorporated by reference.

### BACKGROUND OF THE INVENTION

a) Field of the Invention

The invention is directed to a laser arrangement and a method for the generation of a multimode operation with intracavity frequency doubling.

b) Description of the Related Art

Continuous wave solid state lasers which emit in the transverse TEM₀₀ fundamental mode in the green spectral region are required for many applications, e.g., for pumping Ti:sapphire lasers, in holography, semiconductor processing, or as illumination lasers for forensic applications.

In lasers with intracavity frequency doubling which operate on a single mode, the nonlinear coupling between the longitudinal modes due to sum frequency generation in the SHG crystal used for frequency doubling results in deterministically chaotic laser dynamics. This means that the output power of the laser in the second harmonic exhibits sharp fluctuations in time typically ranging from 10 to 1000 kHz with a modulation depth of up to 100% [T. Baer, J. Opt. Soc. Am. B3, 1175 (1986)].

Lasers of the kind mentioned above are generally unusable for many applications because they react very sensitively to very small disturbances from the environment and, moreover, can have a bistable or multistable behavior with respect to output power and noise.

Attempts at solving this problem are known from K. I. Martin, W. A. Clarkson, D. C. Hanna, Optics Letters 21, 875 (1996) or U.S. Pat. No. 5,446,749.

The first approach uses a unidirectional ring laser which can oscillate in single mode operation as is conventional for homogeneously broadened laser lines. It is known that this approach is very elaborate in terms of technique because an intracavity Faraday rotator must be used to operate the device.

The second approach, according to U.S. Pat. No. 5,446,749, uses a long resonator which emits on more than one longitudinal modes. It is disadvantageous that a residual noise remains due to the fact that the underlying process of spatial hole burning and rapidly changing modes is not eliminated; rather, averaging over the output contributions of very many modes merely reduces the noise amplitude.

In S. Erhard, A. Giesen, M. Karszewski, T. Rupp, C. Stewen, I. Johannsen, K. Contag, OSA TOPS, Vol. 26, Advanced Solid-State Lasers, Martin M. Fejer, Hagop Injeyan, and Ursula Keller (eds.), 1999 Optical Society of America, single longitudinal mode operation is forced in a Yb:YAG disk laser with intracavity frequency doubling by means of a birefringence filter and two etalons. While a high output stability is achieved in this way, forcing the single mode operation causes high output losses, and an output power of only 6.9 W at 515 nm can be achieved from the diode output of 44.5 W, which corresponds to an efficiency of 16%.

Further, it is disadvantageous that a thick etalon is required for stable single mode operation so that a laser of this kind reacts very sensitively in thermal and mechanical respects. This is evidenced by the fact that even changes in optical path length of several nanometers caused by technical sources of interference (temperature, room sound, structure-borne noise, changes in air pressure) cause mode jumps which can lead to temporary outage of the laser and can be overcome only with difficulty.

### OBJECT AND SUMMARY OF THE INVENTION

It is the primary object of the invention to eliminate fluctuations in output caused by the nonlinear coupling between the longitudinal modes due to sum frequency generation in a simple laser construction which has increased thermal and mechanical stability. Further, the solid state laser operates with high efficiency and improved noise behavior at least corresponding to that of single mode lasers.

According to the invention, the above-stated object is met through a laser arrangement for the generation of multimode operation with intracavity frequency doubling containing along the optical axis in a resonator delimited by resonator mirrors
a disk-shaped laser medium which has a gain bandwidth corresponding to the wavelength distance between two multimode spectral regions which oscillate due to spatial hole burning, wherein the wavelength distance Δλ_{SHB} of the center wavelengths of the two spectral regions is given by

$${Δλ}_{SHB} = {λ}_{1} - {λ}_{2} = {λ}_{1} ( 1 - \frac{2 \cdot l \cdot {n}_{disk}}{2 \cdot l \cdot {n}_{disk} + {λ}_{1}} ) ,$$
where λ₁, is the center wavelength of the first spectral region
   λ₂ is the center wavelength of the second spectral region
   λ₁ is the disk thickness
   n _{disk} is the refractive index of the laser disk
an etalon which is adjustable at an inclination to the optical axis and which prevents oscillation of one of the two spectral regions, and
an optically nonlinear crystal for frequency doubling.

The etalon advantageously has a thickness in a range from 0.1 mm to 1 mm that corresponds to the disk thickness of the laser medium and a free spectral region that corresponds to twice the wavelength distance of the center wavelengths of the two spectral regions.

At least one diaphragm provided in the resonator can serve to force a fundamental transverse mode operation with high beam directional stability.

The invention is further directed to a method for generating a multimode operation with intracavity frequency doubling in which two multimode spectral regions are situated in edge areas of the spectral gain region of a disk-shaped gain medium within which longitudinal modes have no gain advantage among one another for spatial hole burning, and in which oscillation of one of the two multimode spectral regions is prohibited.

By multimode spectral region is meant a spectral region in which more than one longitudinal mode can oscillate.

Particularly advisable and advantageous arrangements and further developments of the method according to the invention are indicated in the dependent claims.

The invention has a substantial difference compared with solid state lasers which contain a rod-shaped laser crystal in a standing wave resonator or which are designed as slab lasers and in which the laser oscillates on a plurality of longitudinal modes in the center of the spectral gain region, wherein a continuous change in the intensity of the individual modes occurs due to the spatial hole burning.

It was found that by selecting a laser line with a determined line width of the fluorescent spectrum in a solid state laser with fundamental transverse mode operation and intracavity frequency doubling in which the laser crystal is formed as a flat disk, emission is carried out in two spectral ranges in the near infrared corresponding to FIG. 1 which respectively lie in the edge areas of the spectral gain region. A plurality of longitudinal modes lying close together oscillate in both spectral regions, none of which longitudinal modes can achieve a gain advantage within a spectral region due to the small phase displacement caused by the disk thickness, so that the excitation of a nonlinear dynamic in sum frequency mixing is prevented.

On the other hand, there is strong competition between individual longitudinal modes of one spectral region and individual longitudinal modes of the other spectral region so that, surprisingly, a longitudinal multimode operation in which no spatial hole burning and therefore no mode fluctuation occurs results when one of the two spectral regions is suppressed by means of a thin etalon.

By means of the invention, a very high stability of the practically noiseless output power is achieved in the second harmonic without having to force single mode operation.

The positive effects connected with the invention indicate that spatial hole burning contributes to the nonlinear dynamic with chaotic output fluctuations in intracavity frequency doubling to a greater extent than was previously assumed.

Due to the fact that only one spectral region at a great spectral distance must be eliminated, the thickness of the etalon can be small and, for this reason, no temperature stabilization is required so that losses through the etalon for laser radiation with wavelengths close to the transmission maxima can be kept low.

Another advantage of the thin etalon is that changes in wavelength caused by mechanical interference are small compared with the spectral distance of the transmission maxima so that mode jumps in neighboring transmission maxima are prevented. This enables an operation of the laser that is extremely robust mechanically.

The invention will be described more fully in the following with reference to the schematic drawing.

### BRIEF DESCRIPTION OF THE DRAWINGS

In the drawings:

FIG. 1 shows the construction of two spectral regions in the edge areas of the gain spectrum;

FIG. 2 shows the construction of the diode-pumped solid state laser arrangement according to the invention;

FIG. 3 shows the forming of standing waves in two spectral regions;

FIG. 4 shows the laser spectrum with a disk thickness of the laser crystal of 0.3 mm and intracavity frequency doubling SHG when no etalon is used;

FIG. 5 shows the advantageous noise behavior achieved by the invention as RMS curve; and

FIG. 6 shows the characteristic line of the laser according to the invention which demonstrates the high, twenty-percent efficiency of the laser (diode pump output/green output power).

### DESCRIPTION OF THE PREFERRED EMBODIMENTS

In the present embodiment example shown in FIG. 2, a laser crystal 1 constructed as a flat disk, preferably a Nd:YVO₄ crystal with 0.5% doping and with a disk thickness of 0.3 mm and an edge length of 4 mm×4 mm is used. The laser crystal 1 is soldered with a mirrored back surface of a disk that is highly reflective for laser radiation and pumped radiation to a heat sink 2 so that a resonator end mirror is implemented at the same time. The front surface of the laser crystal 1 is coated so as not to reflect the pump wavelength and laser wavelength.

A curved folding mirror 3 having, for example, a radius of curvature of 300 mm which is coated so as to reflect the laser wavelength and transmit the second harmonic wave and an end mirror 4 which is designed so as to be highly reflective for the laser wavelength and the second harmonic wave complete the resonator.

The resonator contains an optically nonlinear crystal 5 for frequency doubling, for example, a critically phase-matched LBO crystal preferably having a length of 5 mm to 20 mm, a cross-sectional surface of 3 mm×3 mm and a wedge angle for preventing a parasitic etalon effect.

Further, the resonator contains an etalon 6 which is made of BK7 glass in the present embodiment example, has a thickness of 0.3 mm and a diameter of 10 mm and is arranged, for example, so as to be tilted at an angle of 0.5° relative to the optical axis O-O. One or more in-cavity diaphragms, in this instance diaphragms 7.1 and 7.2, force a pure fundamental transverse mode operation and high beam directional stability.

The second harmonic that is generated by the optically nonlinear crystal 5 exits the resonator after the folding mirror 3 as an output beam 8.

A laser diode 9 is provided as pump radiation source for the disk-shaped laser crystal 1. The pump mirror 10 makes it possible for the pump radiation 11 to pass through the laser crystal 1 four times.

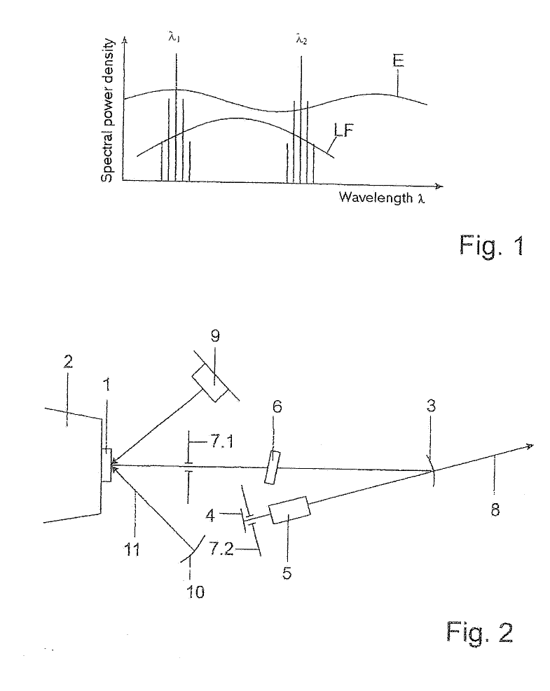

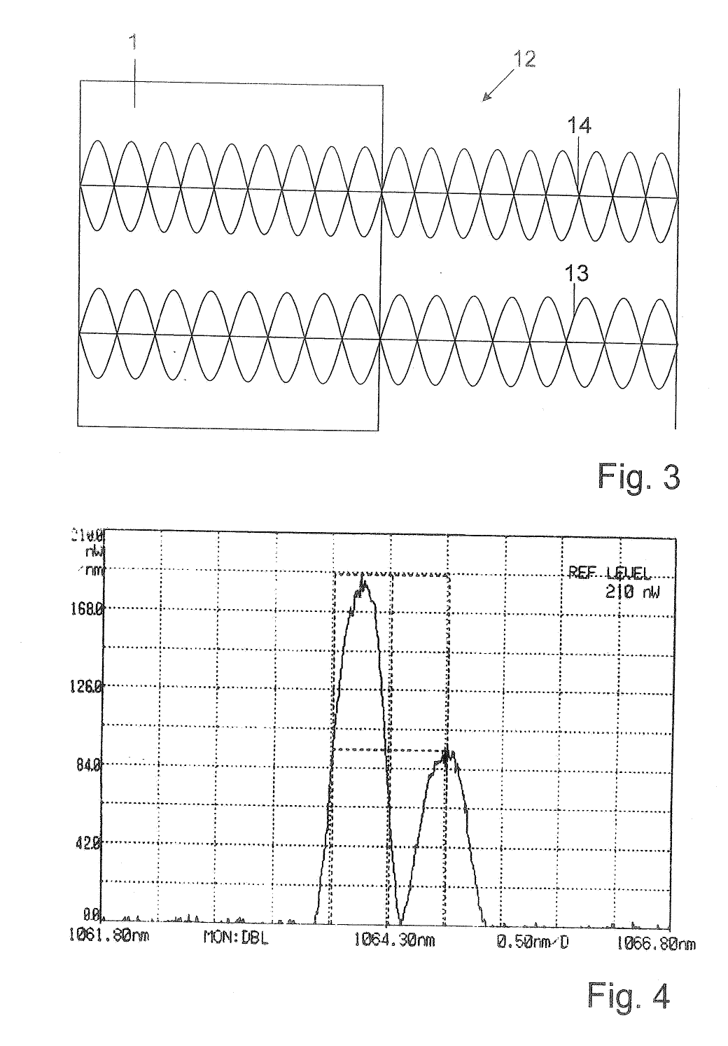

According to FIG. 3, in which the laser crystal 1 which is constructed as a thin disk according to the invention and which is described more fully with reference to FIG. 2 is shown more broadly for purposes of illustration, two standing waves 13, 14 are formed, for energy-related reasons, in two spectral regions around wavelengths λ₁ and λ₂ corresponding to FIG. 1 in the resonator 12. A first standing wave 13 has, for example, a node in the center of the laser crystal 1, whereas the anti-node is located at that position in the second standing wave 14. In FIG. 1, the transmission curve of the etalon 6 used according to the invention is designated by E and the laser fluorescence line is designated by LF.

While the gain of the two spectral regions oscillating on the flanks of the fluorescence spectrum is less than in the center of the fluorescence spectrum, the inversion could not be depleted in the nodes through the laser wave or be lost by spontaneous emission, which would be unfavorable on the whole in terms of energy, with a single oscillation in the maximum of the gain spectrum.

Because of the parasitic etalon effects or as a result of a change in temperature of the optically nonlinear crystal 5, the output content of the two spectral regions can vary and can also fluctuate in time, but two spectral regions always oscillate. Since a frequency mixing of the individual longitudinal modes from the first spectral region with those of the second spectral region is generated by means of the optically nonlinear crystal 5, this leads to sharp fluctuations in output based on a nonlinear dynamic.

For this reason, according to the invention, an etalon 6 with a free spectral region which corresponds to approximately twice the distance of the two spectral regions occurring through spatial hole burning is preferably used in the resonator 12, given in the following equation:

$${Δλ}_{SHB} = {λ}_{1} - {λ}_{2} = {λ}_{1} ( 1 - \frac{2 \cdot l \cdot {n}_{disk}}{2 \cdot l \cdot {n}_{disk} + {λ}_{1}} ) ,$$

where Δλ_{SHB} is the distance of the oscillating spectral regions owing to the spatial hole burning (SHB)
λ₁ is the center wavelength of the first spectral region
λ₂ is the center wavelength of the second spectral region
1 is the disk thickness
n_{disc} is the refractive index of the laser disk.

Empirical results which are shown in FIG. 4 for a disk thickness of 0.3 mm confirm the calculation formula as follows:

| Disk thickness | Δλ [nm] calculated | Δλ [nm] measured |
|---|---|---|
| 0.30 mm | 0.87 | 0.80 ± 10% |
| 0.30 mm | 0.79 | 0.73 ± 10% |

With a free spectral region of

$$Δ {v}_{FSR} = \frac{c}{2 \cdot L \cdot {n}_{etalon}} ,$$

where L is the thickness of the etalon and nₑₜₐₗₒₙ is the refractive index of the etalon, twice the distance between the two spectral regions gives:

$$Δ {v}_{FSR} = 2 \cdot Δ {v}_{SHB} = 2 \cdot \frac{c \cdot {Δλ}_{SHB}}{{λ}_{1}^{2}} .$$

The etalon can be adapted by means of a tilt angle relative to the optical axis corresponding to

$${Δλ}_{Etalon} = - \frac{{λ}_{etalon}}{2 \cdot {n}_{etalon}^{2}} \cdot {θ}^{2} ,$$

where Δₑₜₐₗₒₙ is a wavelength of a transmission line of the etalon, and θ is the tilt angle.

When the etalon is selected, for example, between Δλ=1.3 nm (0.2 mm BK7 etalon) and Δλ=1.8 nm (0.3 mm BK7 etalon), about twice the line width of Nd:YVO₄ of 0.8 nm in every case, an operation can be achieved in only one frequency range even with an uncoated BK7 etalon.

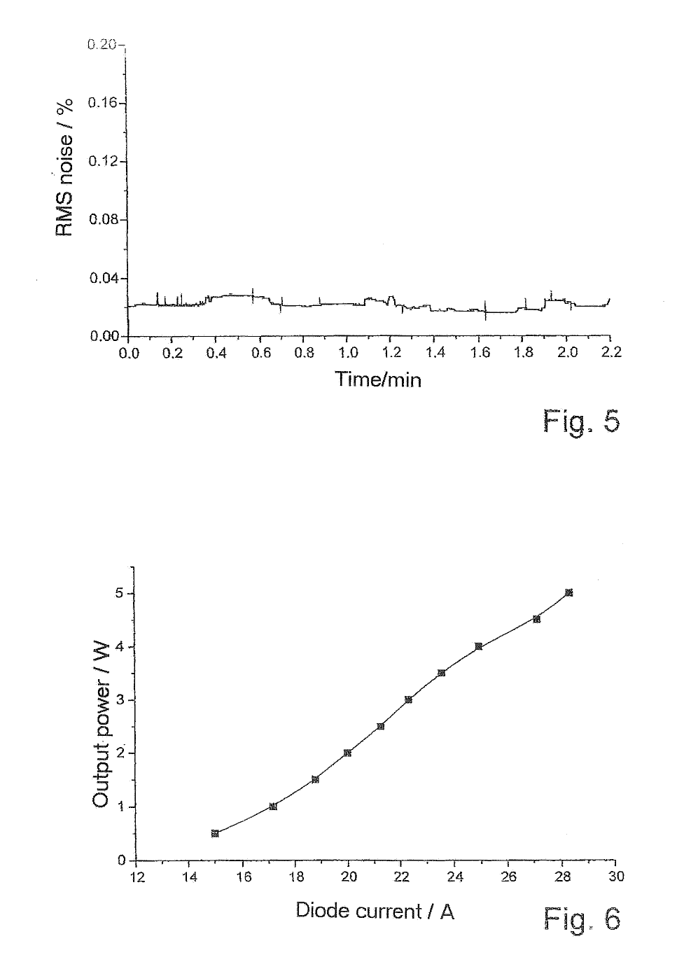

Although the laser oscillates on a plurality of (neighboring) modes (1-10), FIG. 5 shows that a stable frequency-doubled output power (SHG output) having practically no noise (RMS noise <0.2 permil) is achieved and that the laser accordingly has the same excellent noise characteristics which were formerly only known in single mode lasers (single-frequency lasers).

While the foregoing description and drawings represent the present invention, it will be obvious to those skilled in the art that various changes may be made therein without departing from the true spirit and scope of the present invention.

What is claimed is:

1. A laser arrangement for the generation of a multimode operation with intracavity frequency doubling containing along the optical axis in a resonator delimited by resonator mirrors comprising:
a disk-shaped laser medium which has a gain bandwidth corresponding to the wavelength distance between two multimode spectral regions which oscillate due to spatial hole burning, wherein the wavelength distance Δλ_{SHB} of the center wavelengths of the two spectral regions is given by
$${Δλ}_{SHB} = {λ}_{1} - {λ}_{2} = {λ}_{1} ( 1 - \frac{2 \cdot l \cdot {n}_{disk}}{2 \cdot l \cdot {n}_{disk} + {λ}_{1}} ) ,$$
where λ₁ is the center wavelength of the first spectral region
λ₂ is the center wavelength of the second spectral region
1 is the disk thickness
n_{disk} is the refractive index of the laser disk;
an etalon which is adjustable at an inclination to the optical axis and which prevents oscillation of one of the two spectral regions; and
an optically nonlinear crystal for frequency doubling.

2. The solid state laser according to claim 1, wherein the etalon has a thickness corresponding to the disk thickness of the laser medium.

3. The solid state laser according to claim 2, wherein the etalon has a free spectral region that corresponds to twice the wavelength distance of the center wavelengths of the two multimode spectral regions.

4. The solid state laser according to claim 2, wherein the thickness of the etalon is in the range of 0.1 mm to 1 mm.

5. The solid state laser according to claim 1, wherein the resonator contains at least one diaphragm for forcing a fundamental transverse mode operation with high beam directional stability.

6. A method for generating a multimode operation with intracavity frequency doubling comprising the steps of:
situating two multimode spectral regions in edge areas of the spectral gain region of a disk-shaped gain medium within which longitudinal modes have no gain advantage among one another for spatial hole burning; and
prohibiting oscillation of one of the two multimode spectral regions in said gain medium.

7. The method according to claim 6, wherein an etalon having a thickness in the range of 0.1 mm to 1 mm is used for preventing the oscillation of one of the two multimode spectral regions.

8. The method according to claim 7, wherein an etalon having a free spectral region corresponding to twice the wavelength distance of the center wavelengths of the two multimode spectral regions is used.
